(19) United States
(12) Patent Application Publication
(10) Pub. No.: US 2009/0116907 A1
(43) Pub. Date: May 7, 2009

(54) Porous Tube for Exudative Irrigation and Method for Manufacturing the Same

(76) Inventor: Josep Maria Gaya I Altirriba, Barcelona (ES)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 12/296,236

(22) PCT Filed: Apr. 4, 2007
(86) PCT No.: PCT/ES2007/070070

§ 371 Date: Oct. 22, 2008

(30) Foreign Application Priority Data
Apr. 6, 2006 (ES) P 200600974

(51) Int. Cl. A01G 25/06; B32B 37/12

(52) U.S. Cl. 405/45; 138/124; 156/149; 156/320

(57) ABSTRACT

Tubes for exudative irrigation and methods for manufacturing the same are disclosed. The tubes may comprise a core of textile formed by a knitted fabric covered with a covering of porous material which may comprise a resin mixture of acrylic or polyurethane type, plus additives such as for example, plasticizers, dyes, thickeners and biostatic substances adapted to prevent the proliferation of bacteria, algae or fungi. The core may be composed of one or more fibres in the form of a thread as a single textile fibre of thread, woven using a method of self-interlacing, forming horizontal rows of loops, or possibly a warped fabric with independent threads, using a warp method with one needle for each thread, forming vertical columns of loops.

### TECHNICAL FIELD

The present invention relates to the manufacturing of porous tubes for exudative irrigation, of the type which have a core of textile tube, covered with a porous material, that include a mixture of resins and additives, such as for example plasticizers, dyes, thickeners, and the like.

### BACKGROUND

For some time in the agricultural industry and in gardening, the practice of exudative irrigation based on the utilization of tubes provided with pores for the circulation of water, has been well known. By the action of water pressure, the later goes out through the pores and irrigates the surrounding land. The U.S. Pat. No. 254,902, of 29 Jan. 1918 already discloses a system of irrigation of this kind.

Exudative irrigation is cited under patent EP0462038 (with priority to ES 2032239). The disclosed tube is well known in the art and in the agricultural industry for its capacity to convey water that emerges in the form of drops or by means of exudation for irrigation which may be attirbuted to the porosity of its walls. It appears that the disclosed tube comprises an integral core of textile tube that is covered with a porous material composed of a mixture of resin, plasticizer, colloidal smoke black, bactericides, fungicides, algaecides and thickeners. It also appears that the structure and constitution of the tube has height resistance to the action of inorganic and organic agents, as well as high pulling and breakage mechanical strength for irrigation fluid pressure, all which allows its installation, either superficial or buried. The foregoing characteristics appear to provide a tube having a high mechanical flexibility that makes it suitable for the agricultural industry.

The specification of EP0462038 provides that the core of textile tube can be woven according to any chosen process of textile knitting. This patent, however, only describes that the manner to obtain the core by means of flat knitting processes, where two yarns, one for the weft and one for the warp, intertwine in a stretched way forming a uniform structure.

It is known that a flat knitting technique may give the fabric a high degree of stiffness, which can be a drawback in the case of installation of irrigation tubes in agriculture, as stiffer fabric can be more susceptible to breakage (the knitting machines have a maximum performance which at present is of 1000 cycles per minute). Indeed, for manufacturing a fabric with tubular characteristics by the flat knitting technique it is necessary to use the right and left selvedges in order to act as an union seam between the upper and lower fabric, these seams give the tube a structural stiffness additional to that already caused by the own bond of fabric formed during the flat knitting technique.

On the other hand, the porosity that these tubes have, which is desirable to the effects of the correct functionality of exudation, can facilitate, when the tube is buried, the introduction of roots in the tube, and also the destruction of the same. In addition, the abrasiveness of the powders in the resin additives of the porous layers can damage the root ends of the plants to be irrigated.

Furthermore, the tube apparently disclosed in EP0462038 incorporates bactericides, algaecides and fungicides, which can damage the crop, as well as chlorine and phosphorus, which are elements declared unhealthy, dangerous and harmful from the Health and Safety and Environmental point of view.

The aim of the present invention is to provide a global solution to the previous drawbacks.

### SUMMARY

The present invention and specification hereof discloses novel porous tubes for exudative irrigation and methods to produce porous tubes for exudative irrigation.

In an embodiment, the invention is directed to a porous tube for exudative irrigation comprising a core of textile tube and a covering surrounding the core of textile tube, wherein the covering includes porous material having a resin mixture and additives, wherein the additives are selected from the group consisting of plasticizers, dye, thickeners, and wherein the core of textile tube is a knitted fabric.

In an embodiment, a process for manufacturing the above-mentioned tube is revealed, by means of “knitting” processes and in particular by means of a flat knitting technique, in a circular machine having a small diameter, from a unique yarn for each working group which intertwines itself forming horizontal rows or loops.

Depending on the kind of crop to be irrigated, tubes requiring much flexibility along their run can be required, although usually they are mainly straight lines (although flexible). For the later supposition (mainly straight lines), the tube of the present invention using the weft knitting system has been disclosed, since market demands porous tubes for irrigating crops extending in straight lines.

Thus, for harvesting “in line” crops it is preferable to use the weft knitting system with the simplest existing bind since in this way its behaviour, together with that of the resin, will be optimal. Also it is possible to get the most production capacities out of the machine (up to ca 4000 r.p.m.).

The machine will be preferably a “circular” small diameter one and the fabric, according to the invention, is obtained from a unique yarn for each working group that intertwines itself forming horizontal rows or loops.

On the contrary, for applications where it could be necessary that the pipe develop complex circuits with curves, it may be be more suitable to use a warp knitting system. This permits special bounds to be made that give the fabric the ability of acting as an accordion, preserving in this way all the mechanical properties of the fabric and its covering when the exudative effect is working and giving more versatility since one yarn corresponds to each needle, although the productive process is slower (at present at 2.000 r.p.m. only).

According to an embodiment of the invention, the textile tube of the core may be treated with a novel plasma technology to improve the adherence of the resin and thus minimizes the required quantity while improving their permeability and perspiration properties and maintaining at the same time the mechanical strength.

### BRIEF DESCRIPTION OF DRAWINGS

Embodiments of the present invention will be further described in the following with reference to the annexed drawings for better comprehension, which are to be understood as merely illustrative, and in which:

FIG. 1 is a longitudinal section view of of an exudative tube according to an embodiment of the present invention;

FIG. 2 is another longitudinal section view of an exudative tube according to an embodiment of the present invention:

FIG. 3 is a cross section view depicting the tubes shown in preceding FIGS. 1 and 2:

FIG. 4 shows a number of cross sections of a tube with variations of warp knitting bonds for achieving different thickness and elasticity, according to embodiments of the present invention;

FIG. 5 is a schematic view of the manufacturing process of a porous tube for exudative irrigation, according to an embodiment of the present invention;

FIG. 6 is a schematic view of a knitting machine for knitting tubular goods by warp knitting, applicable for the manufacturing of the tube, according to an embodiment of the present invention;

FIG. 7 is a schematic view of a knitting machine for knitting tubular goods by weft knitting, applicable for the manufacturing of the tubes, according to an embodiment of the present invention.

### DETAILED DESCRIPTION

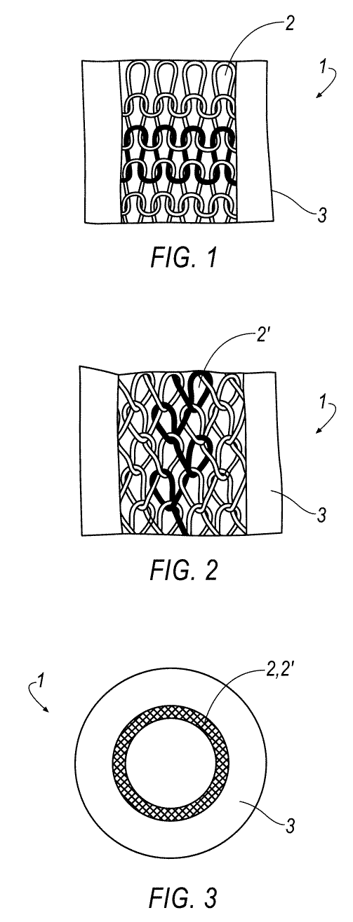

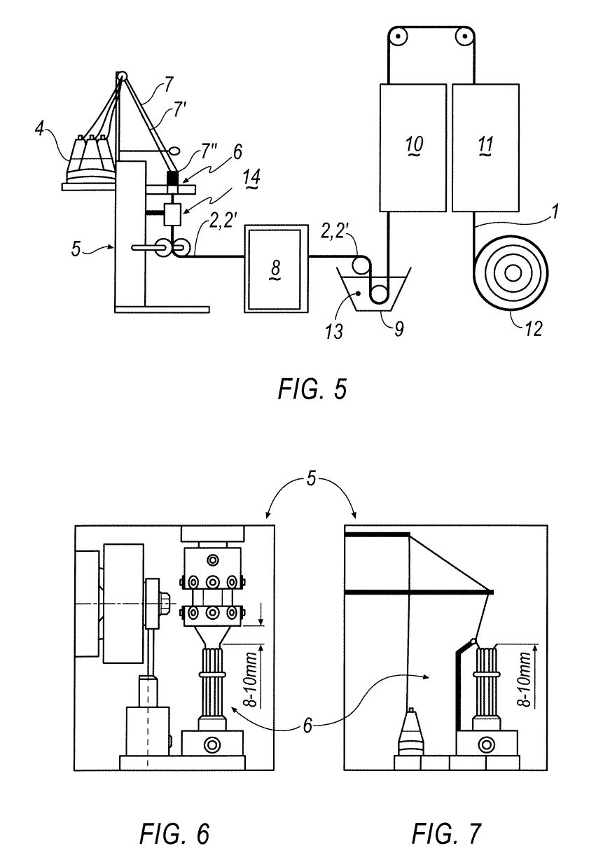

FIGS. 1 through 4 illustrate embodiments of structure and composition for porous tubes for irrigation according the present invention and FIGS. 5 through 6 illustrate embodiments of manufacturing processes directed to manufacturing porous tubes according to the present invention.

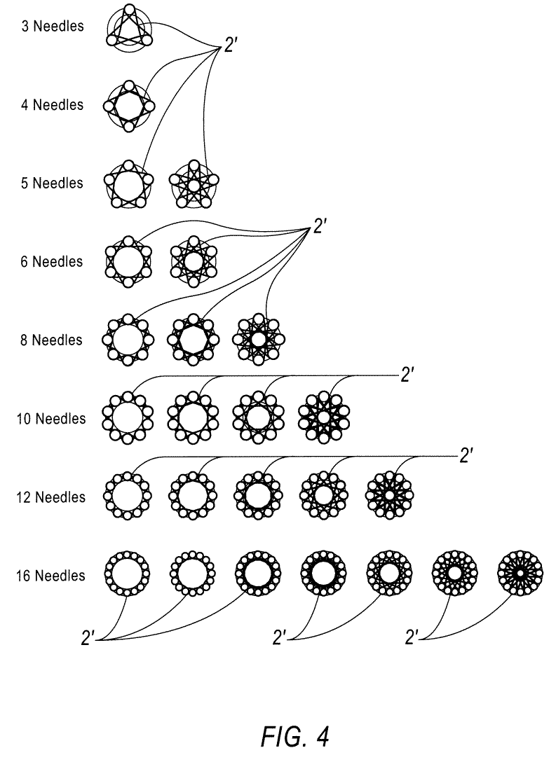

In an embodiment, a tube 1 is formed by a nucleus or core 2 made from a tube of textile material and a covering 3 of porous material, that includes a resin mixture 13; preferably, although not exclusively, of polyurethane, and a number of additives, including but not limited to plasticizers, dyes, thickeners, etc. According to the present invention, the tubular nucleus or core 2 is manufactured by means of a knitting technology, either weft knitting with one yard 7 (FIG. 1, FIG. 4) or warp knitting, with a yarn for each needle 7, 7′, 7″ (FIG. 2).

Tube 1 is applicable in the agricultural industry and gardening for the manufacturing of hoses and pipes for the practice of exudative irrigation on the basis that, attributable to the pores of the core 2 and of the covering 3, and due to the action of the pressure of water, the water goes out through the pores and irrigates the surrounding environment.

As previously discussed, in an embodiment, the core 2 can be a fabric consisting of a unique textile fibre 7 or yarn, woven by means of a self-intertwining process which is known as weft knitting, particularly for the manufacture of tubes 1 intended to be used in the manufacturing of straight sections of hoses for exudative irrigation. In this case, a unique yarn consecutively feeds the needles one after the other, forming horizontal rows of loops (see FIG. 1). As will become apparent to those skilled in the art, when the core 2 of textile tube consists of a unique textile fibre knitted by means of a knitting process with itself i.e. by means of a weft knitting technique, the combination of polyurethane resin and the weft knitting system give it a high temperature resistance (500C.-150° C.) without altering its physical or chemical structure. Furthermore, the manufacturing of the core by means of the weft knitting process allows the direct production of the tube and simplifies the fabrication without requiring intermediate steps, which are usually involved in the weft and warp knitting process (or “flat knitting”) with two yarns.

In another embodiment, core 2 comprises at least three yarns interwoven with three independent yarns 7, 7′, 7″, by means of a warp knitting process with a needle for each yarn (see FIG. 2 and FIG. 3). Each one of the needles of the knitting machine is fed with a different yarn that forms some vertical columns of loops. This process is suitable for applications where the pipe includes complex circuits with curves, as it allows special bonds and provides more versatility because a yarn corresponds to each needle. Additionally, this process gives the knitted tube the property to act as an accordion and thus preserves the mechanical properties of the textile and its covering while the exudative effect may be be carried out. Nevertheless, the productive process is slower (at present is 2000 r.p.m. only). FIG. 4 shows different possible embodiments relating to the cross sections of a tube which form the core, with their bound variations of warp knitting to achieve different thickness and elasticity, depending on the number of needles (between 3 and 30) and if they are arranged contiguous or one or several are “released”. In the illustrated embodiments of the core 2, the porosity of the tube allows the exudative irrigation.

According to an embodiment of the invention, resin 13 can be of an acrylic or polyurethane nature. In addition to those previously cited, additives can include biostatic substances adapted to prevent the proliferation of bacteria, algae or fungi, copper oxides, as well as additive agents to enhance the development of plant roots by forming an entry barrier for the roots. This allows production of a product that contributes the maximum benefits to sustainability from a environmental point of view while offering at the same time the maximum guarantee not to liberate any harmful substances to the crop to which it is destined, as it obviates the employ of fungicides, bactericides and algaecides.

In the resin and in the textile filaments, biostatic substances may be used to avoid the proliferation of bacteria, fungi or algae in the tube. Furthermore, the material of the nucleus or core 2 of textile tube may include natural fibres (e.g., cellulose, cotton, and the like) synthetic fibres, such as polyesters, polyamides, acrylic fibres, and the like, a mixture of synthetic and natural fibres, and/or non-woven fabric.

In an embodiment, the core 2 of the textile tubing can have a dye coating of resin of acrylic nature, pigmented in black colour, preferably containing smoke black, iron and/or copper oxides. The black colour of the surface helps to avoid the irrigation tube from being penetrated by the suns rays, as their effect on the liquid flowing through it can cause an acceleration of eutrophication that can arise from the confluence of fermentor broth (phosphorous, nitrates and potassium) and high temperatures. This effect can strongly reduce the properties of the tube as it could result in the proliferation of algae in its interior. In an embodiment, this pigmentation can be achieved by mixing natural pigments mainly with iron and copper oxides. This composition may also help to avoid the penetration of roots inside the exudative tube, causing the ablation of the root ends that come into contact with the tube and generating a bifurcation of the same which would result in a more vigorous root. The resulting black colour may be intensified with smoke black.

With reference now to FIG. 5, a system for manufacturing a porous tube is shown, in accordance with an embodiment of the present invention.

In an embodiment, yarn or yarns 7, 7′, 7″ are fed for example from coils 4 to a circular knitting machine 5, in whose head 6 they are knitted by means of a weft knitting technique (a unique yarn 7 for each working group, feeding the needles one after the other), or a warp knitting technique (a yarn 7, 7′; 7″, for each needle). From the knitting machine 5, a tubular material which forms the core 2 6 2′ of the porous tube of the present invention, is obtained.

In an embodiment, the tubular material, resulting from the knitting process, may be subjected to a heat source 14 in order to heat seal its textile structure before initiating a resin treatment process.

In an embodiment, the core 2, 2′ may be processed by submitting the core 2, 2′ to plasma treatment in a plasma station 8 to improve the adherence of the resin that will be subsequently applied as a coating, which will be described in further detail hereinbelow. This minimizes the quantity used as well as improves its properties of permeability and perspiration, maintaining at the same time the mechanical strength.

Concisely, it may be said that the plasma, which is known as the “fourth state of the material”, is a partially ionised gas containing highly reactivate particles (ions, electrons, radicals, photons, neutral particles and molecules in excited electronic states). This ionised gas is the result of the interaction with an electromagnetic field, under suitable conditions of pressure.

There are several ways for inducing the ionisation of the gases, depending on the technology that is being applied: luminescent discharge, “Glow discharge”, crown discharge and discharge by dielectric breakdown of air.

With continued reference to FIG. 5, the plasma treatment can be carried out directly to the yarns or to the resulting tubular textile obtained from the knitting system. Concerning the plasma treatment of the core 2, 2′, when the used gases are of inorganic nature, namely: argon, oxygen, air, nitrogen, it can produce degradations in the external morphology of the knitting substrate, atom implantation and radical generation. This may be commonly referred to as cleaning and activation of the surface of textile substrates.

In an embodiment, the molecules of gases such as nitrogen and oxygen interact with the chemical groups of the surface of the substrate and form hydroxyl (OH), carbonyl (CO), carboxyl (—OOOH), amino (—NH2) and amido (—NHCO) groups. The]]y in turn modify the surface properties from hydrophobic to hydrophilic; increment the adhesion, the wetting and the biocompatibility, which are phenomenon's that are difficult to produce in conventional methods.

Those species that are generated in the plasma are suitable for producing physical modifications and chemical reactions in the surface of the substrates submitted to the plasma action. The kind of modification or reaction depends on the nature of the plasma gases, on the level of energy applied and on the nature of the substrate (in this case the yarns 7, 7′, 7″), which capacity of absorption is directly related to the value of the angle of contact, or angle forming the tangent of the surface of the drop of a liquid on the textile and/or solid material.

Following the plasma treatment, in an embodiment, the core 2, 2′ is subjected to a resin coating process 13, for example by soaking it in a bath of resin 3 in which also the additives are introduced, all of them in a fluid condition.

In an embodiment, following the resin coating process 13, the core 2, 2′ embedded of the resin mixture 13 and additives, may be subjected to drying, for example, in a drying chamber 10, from which it is next passed to a polymerisation chamber 11 for the resin setting 13. Thereafter, tube 1 leaves the polymerisation chamber already manufactured.

Lastly, tube 1 is packed, for example after being previously coiled in a coil 12, for storage and expedition.

When the core 2 is produced by means of a weft knitting technique, it is preferable to use a circular machine 5 having small diameter 5, employing between 8 and 36 needles per inch in the perimeter of the cylinder, for diameters of cylinders between 3 mm and 60 mm. The knitting system in a circular machine having a small diameter, in which the textile nucleus or core 2 is obtained from a unique yarn for each working group that intertwines it self forming horizontal rows or loops, is the only one that at present allows a greater knitting production for time unit as compared to other knitting technologies that produce similar products. The specific characteristics of this system facilitate the ability to knit loops that give some unique properties of thickness and provide means to adapt the system to make a product with specific desired characteristics as the system allows:

Increasing the thickness of the quantity of resin 13 in each transversal unit of the fabric.

Giving a lot of physical consistence to the product that improves the manipulative conditions of the porous tube 1.

Flexibility allowing a good adaptation to the environment.

Flexibility for the connexion to the pins where it has to be connected when it is working.

Ability to support expansions due to the freezing effects on the pipe.

The above properties would be impossible to obtain using other knitting methods such as flat knitting.

Furthermore, the core 2 produced by the knitting technique disclosed herein has textile uniformity around its entire perimeter. Using the alternative flat knitting system to construct a tube, it is necessary to prepare the machine to make two flat fabrics while being joined by their selvedge. This selvedge gives uniformity to the fabric and accordingly a uniform effect of exudation in the perimeter of the tube but at the same time it subtracts a certain amount of flexibility as it has a different structure.

To obtain the knitted fabric it is necessary to allow the intervention of two elements, namely: the yarn and needle. With the controlled movement of the needles, the yarn intertwines itself, forming loops, connected one to the other by means of interloops.

Although at this point the description of the invention should be sufficiently clear for those skilled in the art, for a greater understanding a summary explanation of an embodiment of a flat knitting technique that may be applied in the present invention.

In an embodiment, the weft-knitting loop is formed inside the head due to the interpenetration between the yarn guide, the front main bed, the cam assembly and the needles.

In an embodiment, the yarn guide is the element responsible for feeding the unwound yarn from the holder devices to the needles. The needles collect the yarn, which has been fed by the yarn guide and transform it into fabric. The latch needles and the composite needles being those used in this invention, each one depending on the desired production speeds and the type of loop to knit. In order that the tissue has the maximum uniformity in the aspect of loops, the needles will work inside the prearranged front main bed.

Depending on the movement of the needles, the loops can be completed, loaded or retained. A completed loop is ready for using in the fabrics manufacturing.

In an embodiment, this knitting system can be used with pressing rollers to achieve a more closed knit effect with the intention of producing pipes able to work at higher pressures. It is also possible to obtain a more closed loop when knitting synthetic materials, such as polypropylene and polyester (mono or multi-filament yarns). This effect will be further enhanced after applying heat to the tubular fabric, as it will seal by the heat effect 14 and will strengthen its structure.

According to the present invention it is preferable to use gauges ranging from size 8 and size 36, in other words, between 8 and 36 needles per inch in the perimeter of the cylinder, for cylinder diameters between 3 mm and 60 mm.

These needles will form a type of loop due to the cam assembly moving forward and backward which are responsible for imparting motion to needles. Thus, the cam assembly determines the quantity of yarn to be drawn and, as a consequence, the length of loop, which will be produced at the minimum possible due to the invention.

In addition, in an embodiment, this system employs a creel that holds the raw material that is fed to the machine and a bed frame where the entire knitting device is situated.

In order to produce a fabric with tubular characteristics using the flat knitting technique, according to the previous state of the art, it is necessary to use the right and left selvedges as a seam of union between the upper and the lower fabrics. This seam gives the tube a structural stiffness additional to that already provided by the bond of a fabric formed according to the flat knitting technique. It will be apparent to those skilled in this art that this methodology gives the tube a much increased stiffness than that produced by the knitting technology used by the weft or warp knitting system of textile tube 1. The existence of the selvedges in the flat knitting technology do not allow a total uniformity around the entire perimeter of the tube because of the seams. With the technique of the present invention, due to to the technology of a knitting circular machine having a small diameter, all the perimeter of the tube is uniform, allowing uniform exudation around the entire perimeter of the tube.

1-15. (canceled)

16. A porous tube for exudative irrigation comprising;
a core of textile tube;
a covering surrounding the core of textile tube, wherein the covering includes porous material having a resin mixture and additives, wherein the additives are selected from the group consisting of plasticizers, dye, thickeners, and wherein the core of textile tube is a knitted fabric.

17. A porous tube for exudative irrigation according to claim 18, wherein the core of textile tube includes one or more fibres in the form of yarn in a unique textile fibre.

18. A porous tube for exudative irrigation according to claim 18, wherein the core of textile tube includes yarn intertwined with itself and includes horizontal rows of loops.

19. A porous tube for exudative irrigation according to claim 18, wherein the core of textile tube consisting independent yarns interwoven by means of a process of warp using a needle for each yarn, and wherein the core of textile tube includes vertical columns of loops.

20. A porous tube for exudative irrigation according to claim 18, wherein the resin mixture includes a resin selected from the group consisting of an acrylic and a polyurethane.

21. A porous tube for exudative irrigation according to claim 18, wherein one or more of the cover, the covering or the resin includes biostatic substances to prevent the proliferation of bacteria, algae and fungi.

22. A porous tube for exudative irrigation according to claim 18, wherein the core is composed of a material selected from the group consisting of: one or more natural fibres, one or more synthetic fibbers, or a mixture of synthetic and natural fibres.

23. A porous tube for exudative irrigation according to claim 18, wherein the resin includes copper oxides as additives to enhance the development of plant roots as a barrier for avoiding the penetration of roots.

24. A porous tube for exudative irrigation according to claim 18, wherein the core of textile tube has a dye coating of a resin of acrylic nature pigmented in black colour.

25. A porous tube for exudative irrigation, according to claim 24, wherein the dye coating includes materials selected from the group consisting of: smoke black, iron, copper oxides and a combination thereof.

26. A process for manufacturing a porous tube for exudative irrigation having a core of textile tube covered by a covering of porous material that includes a mixture of resin and additives, such as plasticizers, dye, thickeners, and the like, the method comprising the steps of:
knitting the textile tube in a knitting machine;
covering the textile tube of the porous material.

27. A process according to claim 26, wherein the textile tube includes one or more working groups and wherein the knitting step further comprises the substep of:
knitting the textile tube using a weft knitting method using a unique yarn for each working group, wherein each unique yarn intertwines itself to form horizontal rows of loops.

28. A process according to claim 26, wherein the textile tube includes at least three yarns and wherein the knitting step further comprises the substep of:
knitting the textile tube using a warp knitting method, wherein the knitting machine includes at least one needle for each of said at least three yarns.

29. A process according to claim 27, wherein the knitting method further comprises the substep of:
using a circular machine having a cylinder diameter between about 3 mm and 60 mm and employing between 8 and 36 needles per inch around the perimeter of the cylinder.

30. A process according to claim 26, further comprising the step of:
subjecting the core of textile tube to a plasma treatment to improve the adherence of the porous material.

31. A process according to claim 30, further comprising the step of:
subjecting the core of textile tube to a treatment of heat-setting to give more consistence to the structure of the fabric.

32. A process according to claim 28, further comprising the step of:
subjecting the core of textile tube to a treatment of heat-setting to give more consistence to the structure of the fabric.

33. A process according to claim 27, further comprising the step of:
subjecting the core of textile tube to a plasma treatment to improve the adherence of the porous material.

34. A process according to claim 33, further comprising the step of:
subjecting the core of textile tube to a treatment of heat-setting to give more consistence to the structure of the fabric.

35. A process according to claim 28, further comprising the step of:
subjecting the core of textile tube to a plasma treatment to improve the adherence of the porous material.
